(19) United States
(12) Patent Application Publication
(10) Pub. No.: US 2020/0074079 A1
(43) Pub. Date: Mar. 5, 2020

(54) METHOD AND SYSTEM FOR CHECKING MALICIOUS HYPERLINK IN EMAIL BODY

(71) Applicant: SOFTCAMP CO., LTD., Gyeonggi-do (KR)

(72) Inventor: Hwan-Kuk BAE, Gyeonggi-do (KR)

(21) Appl. No.: 16/614,044

(22) PCT Filed: Apr. 6, 2018
(86) PCT No.: PCT/KR2018/004071

§ 371 Date: Nov. 15, 2019

(30) Foreign Application Priority Data
May 19, 2017 (KR) 10-2017-0062100

(51) Int. Cl. G06F 21/56; H04L 29/06

(52) U.S. Cl. CPC G06F 21/56; H04L 63/1416; H04L 63/1441

(57) ABSTRACT

Provided is a method and system for checking a malicious hyperlink address in an e-mail body, which identify a hyperlink address appearing in an e-mail body, check whether the hyperlink address is malicious, and prevent an e-mail recipient from accessing a malicious website through the hyperlink address. The system for checking a malicious hyperlink in an e-mail body includes: an address DB which stores one or more of a hyperlink address and recipient information and a substitute address; a recipient DB which stores the identification information of a recipient and website address information related to whether access has been approved input by the recipient; a hyperlink address substitution module which extracts a hyperlink address, and substitutes the hyperlink address with a substitute address; a hyperlink address checking module; a checking information notification module; and an access management module.

### BACKGROUND

The present invention relates to a method and system for checking a malicious hyperlink address in an e-mail body, which identify a hyperlink address appearing in an e-mail body, check whether the hyperlink address is malicious, and prevent an e-mail recipient from accessing a malicious website through the hyperlink address.

E-mail, which is an online mailing means, has established itself in daily life as a basic communication means capable of delivering a message of a sender to a recipient regardless of time and place. Information is exchanged between individuals by using e-mail, and also e-mail is widely used as a communication means for delivering various types of guide information of a public office or typical corporation to recipients.

However, since e-mail has contained not only advertising information which a recipient does not want but also various types of phishing e-mails and malware which may cause monetary or psychological damage to a recipient, e-mail has been used as a malicious communication means which illegitimately divulges the personal information of a recipient or causes financial damage to a recipient.

As these malicious emails flood, various conventional security technologies for emails have been developed. These conventional security technologies filter out e-mails containing malicious code as well as typical spam mails, and enable a recipient to selectively view e-mails, thereby enabling the recipient to receive and utilize e-mails more securely.

Meanwhile, a URL address (hereinafter referred to as a “hyperlink address”) of a specific website must appear in an e-mail body, and thus a recipient can easily access a specific website simply by clicking on the hyperlink address. Such a hyperlink address provides the convenience of eliminating the inconvenience of inputting a corresponding URL address into a web browser in order to access a website.

However, in order to circumvent the security functions of the above-described conventional security technologies, a recent malicious e-mail does not include malicious code in the e-mail itself, but includes the malicious code in the corresponding website of a hyperlink address appearing in an e-mail body. As a result, when a recipient accesses the website through the hyperlink address, the malicious code included in the website of the hyperlink address contaminates the terminal of the recipient and divulges various types of personal information included in the receiving terminal.

Although it is apparent that the conventional security technologies are equipped with the function of checking a hyperlink address for its own risk while storing and managing one or more hyperlink addresses including malware as management data, the hyperlink address of a website contaminated with malware continues to be updated to a new address, and thus there is a limitation on filtering out the malicious hyperlink address of a new address by means of only existing management data.

As a result, the conventional security technologies are not equipped with the security function of filtering out contamination with malware through a hyperlink address, and thus a problem occurs in that a terminal is contaminated with malware and damaged when a recipient unintentionally clicks on a hyperlink address or an image or text containing a hyperlink address.

In order to solve this problem, there has been developed another conventional security technology for detecting malicious code using a sandbox. In this sandbox method, the body or attached file of an e-mail is viewed in an isolated sandbox environment, and thus whether or not a receiving terminal 20 has been infected can be securely detected. However, this conventional security technology using a sandbox has a limitation in that it does not detect phishing through a link address appearing in an e-mail body.

Meanwhile, there has been developed another conventional security technology for checking a hyperlink address for its maliciousness based on a malicious address list. However, this security method can filter out only malicious addresses which are included in a malicious address list when checking is performed, and the malicious address list can be updated with most malicious addresses only after a few days from the time at which they are generated. Accordingly, this conventional security technology has a limitation in that it cannot filter out new malicious addresses.

Moreover, there has been developed another conventional security technology using the fact that access traffic increases abnormally when a recipient selects a hyperlink address in the case where the hyperlink address appearing in an e-mail body is a malicious address. This conventional security technology considers a corresponding hyperlink address to be a malicious address and then restricts the execution of the hyperlink address when the amount of access traffic exceeds a reference value. However, the security method of this conventional security technology generates a significant network load and causes a delay problem in which a recipient cannot access the Internet until checking is completed, and thus this conventional security technology has a limitation in that a method of checking a hyperlink address is malicious is inefficient.

### SUMMARY OF THE INVENTION

Accordingly, the present invention has been conceived to overcome the above-described problems, and an object of the present invention is to provide a method and system for checking a malicious hyperlink address in an e-mail body, which can prevent an e-mail contaminated with malware, spam or the like from being received and can allow the corresponding website of a hyperlink address appearing in an e-mail body to be accessed after being verified in advance, thereby enabling a recipient to securely receive an e-mail and to perform information communication.

In order to accomplish the above object, the present invention provides a system for checking a malicious hyperlink in an e-mail body, the system including: an address DB which stores one or more of a hyperlink address and recipient information, and a substitute address; a recipient DB which stores the identification information of a recipient, and website address information related to whether access has been approved input by the recipient; a hyperlink address substitution module which extracts a hyperlink address appearing in an e-mail body, substitutes the hyperlink address with a substitute address, and stores one or more of the corresponding hyperlink address and recipient information and the substitute address in the address DB; a hyperlink address checking module which, when the execution of the substitute address by the e-mail module of a receiving terminal having accessed an e-mail server is detected, searches the address DB for the corresponding hyperlink address, accesses a checking target website within an isolated virtual area by means of its own web browser, and checks whether or not the checking target website is malicious; a checking information notification module which captures a screen of the checking target website accessed by the hyperlink address checking module, transmits a corresponding capture image to the receiving terminal, and transmits a result of the checking of the checking target website from the hyperlink address checking module to the receiving terminal; and an access management module which searches the recipient DB for the hyperlink address identified by the hyperlink address checking module and determines whether to access the corresponding website based on whether access have been approved for each website address.

In order to accomplish the above object, the present invention provides a method for checking a malicious hyperlink in an e-mail body, the method including: a hyperlink address substitution step at which the hyperlink address substitution module of a substitution server extracts a hyperlink address appearing in an e-mail body, substitutes the hyperlink address with a substitute address, and stores one or more of the corresponding hyperlink address and recipient information and the substitute address in an address DB; an e-mail checking step at which the e-mail module of a receiving terminal accesses an e-mail server and checks a received e-mail; a target website checking step at which a hyperlink address checking module searches the address DB for a hyperlink address with respect to the substitute address and an access management module searches a recipient DB, in which the identification information of a recipient and website address information related to whether access has been approved input by the recipient have been stored, for the hyperlink address and determines whether to access a website of the hyperlink address; a hyperlink address checking step at which whether to access the checking target website is determined based on whether to access the hyperlink address determined at the target website checking step, the hyperlink address checking module, when whether to access is not determined at the target website checking step, accesses the checking target website of the hyperlink address retrieved from the address DB and then checks whether the checking target website is malicious within an isolated virtual area, and a checking information notification module captures a screen of the checking target website accessed by the hyperlink address checking module and transmits a corresponding capture image to the receiving terminal; and a step at which the checking information notification module transmits information about a result of the checking of the checking target website and the capture image, received from the hyperlink address checking module, to the receiving terminal.

The present invention has the effect of preventing an e-mail contaminated with malware, spam or the like from being received and allowing the corresponding website of a hyperlink address appearing in an e-mail body to be accessed after being verified in advance, thereby enabling a recipient to securely receive an e-mail and to exchange information.

Furthermore, the present invention has the effect of significantly reducing the load of a security system and executing a security function at a faster security speed because it is sufficient if a security function for corresponding maliciousness prevention is performed only when a user clicks on a hyperlink address without performing maliciousness prevention on each received e-mail.

### BRIEF DESCRIPTION OF DRAWINGS

FIG. 1 is a diagram schematically showing the network connection configuration of a checking system according to the present invention;

FIG. 2 is a block diagram showing one embodiment of the checking system according to the present invention;

FIG. 3 is a flowchart sequentially showing one embodiment of a checking method according to the present invention;

FIG. 4 is an image showing an embodiment of an e-mail body which is checked by the checking system according to the present invention;

FIGS. 5 and 6 are images showing embodiments of the source code of the e-mail body shown in FIG. 4;

FIG. 7 is an image showing an embodiment in which the checking system according to the present invention shows a webpage of an e-mail hyperlink address and raises a query;

FIG. 8 is a block diagram showing another embodiment of the checking system according to the present invention; and

FIG. 9 is a flowchart sequentially showing another embodiment of the checking method according to the present invention.

### DETAILED DESCRIPTION OF THE INVENTION

The above-described features and effects of the present invention will be apparent from the following detailed description given in conjunction with the accompanying drawings, and thus those having ordinary skill in the art to which the present invention pertains can easily practice the technical spirit of the present invention. The present invention may be subject to various modifications and may have various forms, and specific embodiments will be illustrated in the drawings and described in detail in the specification. However, this is not intended to limit the present invention to specific disclosure, but it should be understood that all modifications, equivalents, and substitutes included in the spirit and scope of the present invention are included. The terns used herein are used merely for the purpose of describing specific embodiments, and are not intended to limit the present invention.

Specific details of the present invention will be described in detail below based on the accompanying drawings.

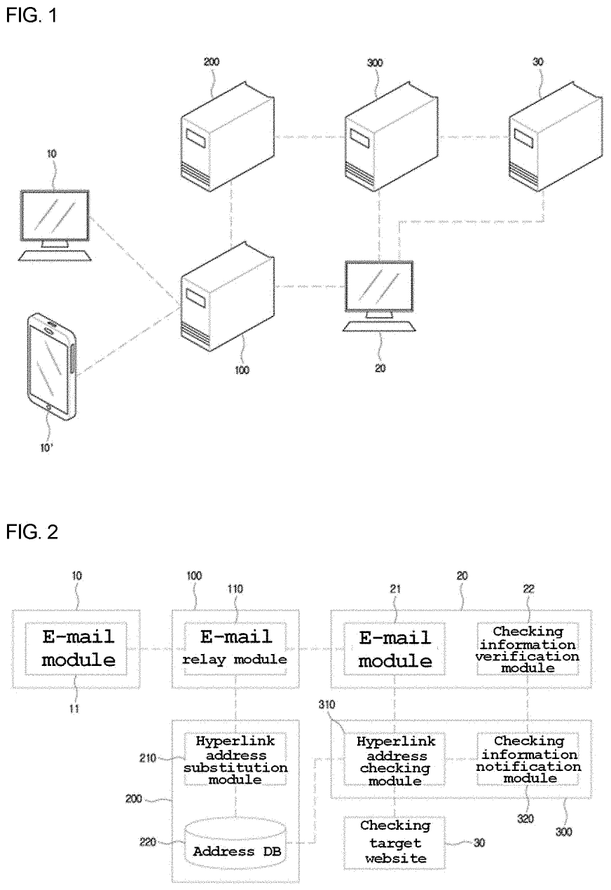

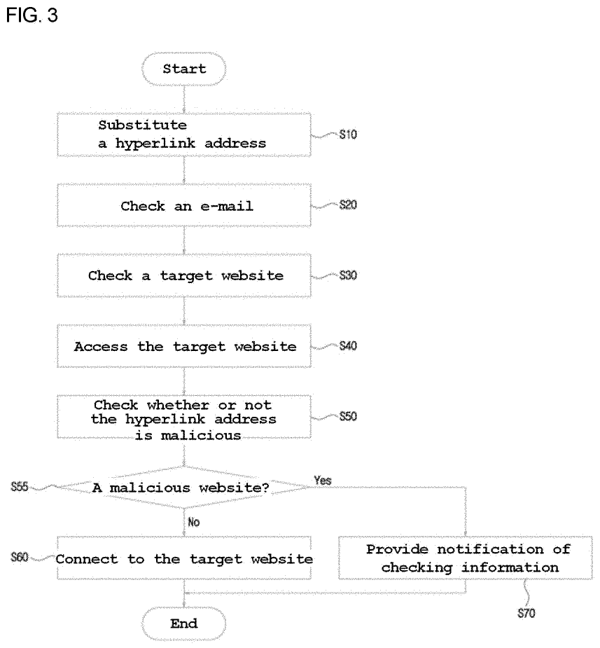

FIG. 1 is a diagram schematically showing the network connection configuration of a checking system according to the present invention, and FIG. 2 is a block diagram showing the checking system according to the present invention.

A checking system according to the present embodiment includes: a substitution server 200 which identifies a hyperlink address included in an e-mail body and substitutes the hyperlink address with a substitute address; and a checking server 300 which detects the access of a web browser through the substitute address and checks the website of the corresponding hyperlink address.

As is well known, a sender and a recipient may send and receive e-mail data by means of communication terminals, such as a laptop(s) 10 and/or 20, a mobile terminal(s) 10′ and/or 20′, a tablet(s), and/or the like connectable to a communication network, and an e-mail server 100 relays e-mail communication between a sending terminal 10 or 10′ (hereinafter “10”) and a receiving terminal 20 or 20′ (hereinafter “20”).

The substitution server 200 includes: a hyperlink address substitution module 210 which extracts a hyperlink address from an e-mail body included in e-mail data and substitutes the hyperlink address with a substitute address; and an address DB 220 which pairs the hyperlink address and the substitute address and stores the paired information.

The checking server 300 includes: a hyperlink address checking module 310 which, when detecting a communication attempt of a web browser through the substitute address, searches the address DB 220 for one or more selected between the corresponding hyperlink address and recipient information and determines whether a checking target website 30 is malicious; and a checking information notification module 320 which applies the communication of the web browser for the checking target website 30 according to the result of the checking by the hyperlink address checking module 310 and provides notification of checking information. Although the checking server 300 of the present embodiment is described as a server independent of the substitution server 200 in terms of hardware, the substitution server 200 and the checking server 300 may be integrated with each other in terms of hardware.

Meanwhile, the checking system of the present embodiment includes a checking information verification module 22 which outputs the checking information via the receiving terminal 20 while communicating with the checking information notification module 320 and transmits the input information of the receiving terminal 20 to the checking server 300.

A method of checking whether or not a hyperlink address is malicious via the above-described checking system of the present embodiment will be described in detail below.

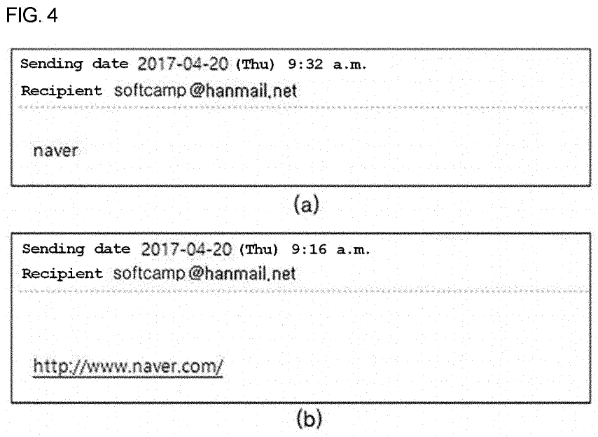

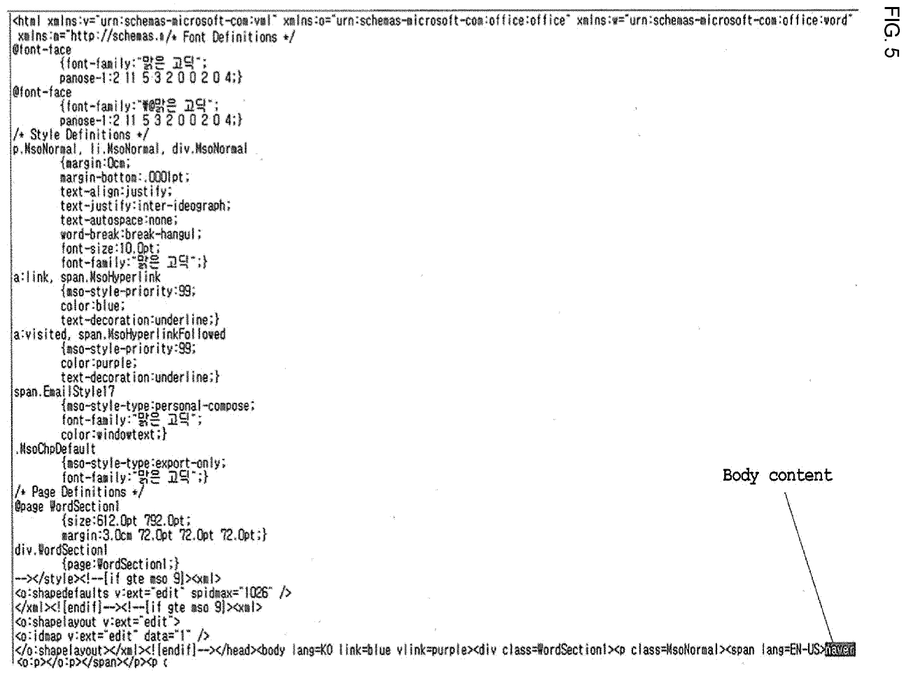

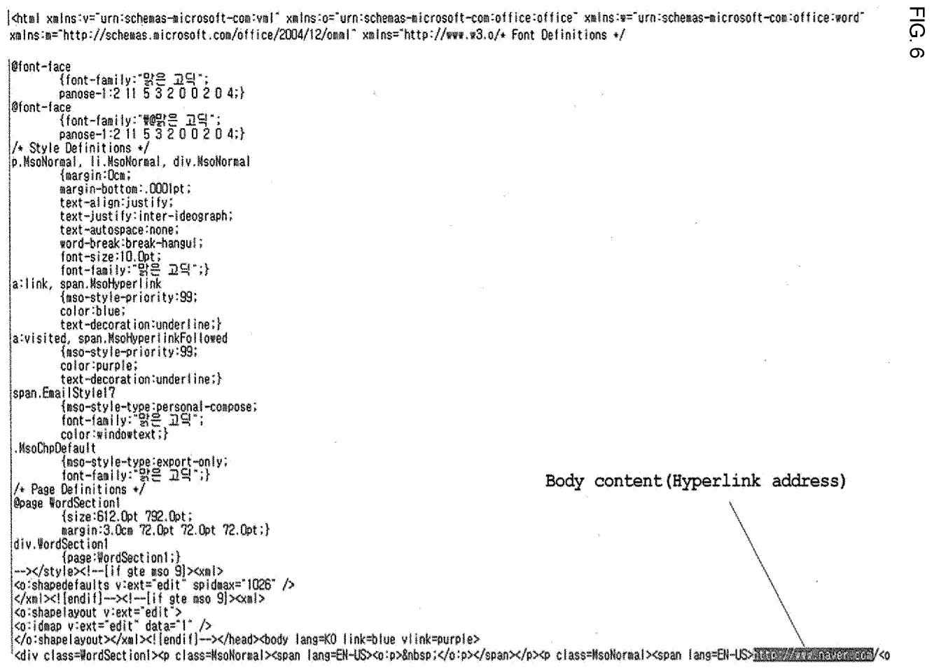

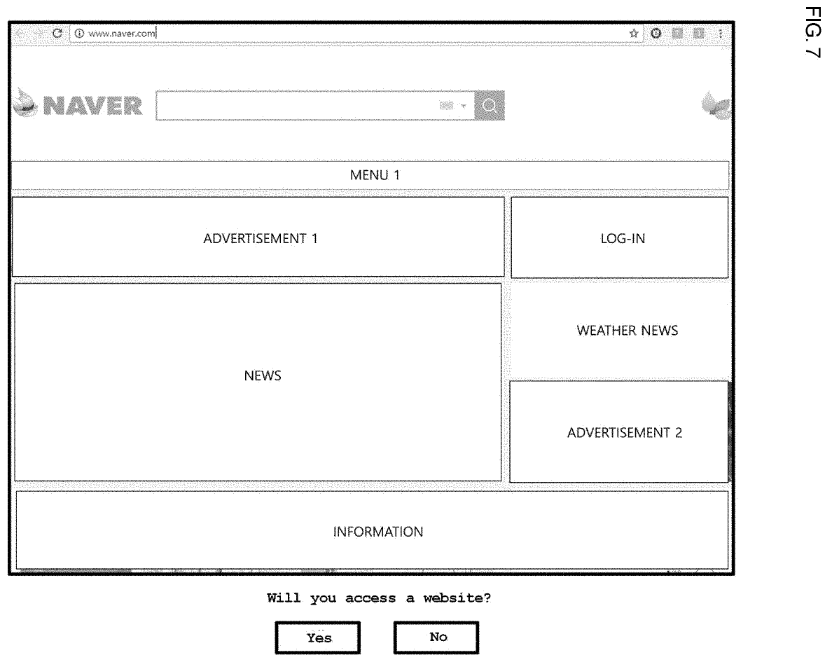

FIG. 3 is a flowchart sequentially showing one embodiment of a checking method according to the present invention, FIG. 4 is an image showing an embodiment of an e-mail body which is checked by the checking system according to the present invention, FIGS. 5 and 6 are images showing embodiments of the source code of the e-mail body shown in FIG. 4, and FIG. 7 is an image showing an embodiment in which the checking system according to the present invention shows a webpage of an e-mail hyperlink address and raises a query.

S10: Hyperlink Address Substitution Step

The checking method of the present embodiment starts with changing a hyperlink address appearing in an e-mail body to a substitute address which is the address of the checking server 300.

Examples of a communication method for substituting a hyperlink address appearing in an e-mail body may include a proxy method, a bridge method, and an address substitution method via an Em1 file. In the following, the communication method for substituting a hyperlink address will be described based on a proxy method.

For reference, the proxy method changes the MX recode of a DNS server so that the substitution server 200 first receives an e-mail bound for the e-mail server 100, substitutes a hyperlink address with a substitute address, and delivers the e-mail, the hyperlink address of which has been substituted with the substitute address, to the e-mail server 100.

The bridge method substitutes a hyperlink address with a substitute address by locating the substitution server 200 in line with the e-mail server 100 and setting SMTP traffic to the e-mail server 100 to the substitution server 200.

The address substitution method via an Eml file transfers an e-mail, which is a target for the substitution of a hyperlink address, from the e-mail server 100 to the substitution server 200 in the form of an Em1 file, and causes the substitution server 200 to substitute a hyperlink address with a substitute address.

FIG. 4(a) shows an e-mail body in which the word “naver” appears, and FIG. 4(b) shows an e-mail body in which the URL address “http://www.naver.com/” appears as a hyperlink address.

Meanwhile, the content of the e-mail body shown in FIG. 4(a) includes a general word, and thus only “naver” is found in the source code shown in FIG. 5. In contrast, the content of the e-mail body shown in FIG. 4(b) includes a hyperlink address in a URL form, and thus “http://www.naver.com/” is found in the source code shown in FIG. 6.

The hyperlink address substitution module 210 of the substitution server 200 analyzes the source code of an e-mail, sent by a sender, in conjunction with the e-mail relay module 110 of the e-mail server 100, and checks whether the hyperlink address shown in FIG. 6 is present.

Thereafter, the hyperlink address substitution module 210 changes the hyperlink address, found in the e-mail body, to the substitute address of the checking server 300. Referring to an example, “http://www.naver.com/” which is a hyperlink address included in the source code of an e-mail body is changed to “http://TEST1.com/” which is the URL address of the checking server 300. As a result, “http://www.naver.com/” which is an original hyperlink address appearing in an e-mail body is changed to “http://TEST1.com/” which is a substitute address.

After the changing of the hyperlink address to the substitute address has been completed, the hyperlink address substitution module 210 associates the hyperlink address and the substitute address, or the hyperlink address, the substitute address and the recipient information, and stores the associated information in the address DB 220. In this case, the recipient information may be the e-mail address of a recipient.

For reference, the e-mail server 100 relays the sending and reception of e-mails between numerous senders and recipients, and an e-mail body may include numerous hyperlink addresses. Accordingly, the hyperlink address substitution module 210 of the present embodiment pairs various different substitute addresses with respective hyperlink addresses. In other words, when hyperlink addresses appearing in an e-mail body are the two addresses “http://www.naver.com/” and “http://www.daum.net/,” the hyperlink address substitution module 210 pairs “http://www.naver.com/” with the substitute address “http://TEST1.com/” and also pairs “http://www.daum.net/” with the substitute address “http://TEST2.com/.”

However, the different addresses “http://TEST1.com/” and “http://TEST2.com/” are enabled to connect to the same checking server 300, and thus a connection is made only to the checking server 300 no matter which substitute address a recipient selects.

Alternatively, the hyperlink address substitution module 210 of another embodiment may change a hyperlink address, appearing in an e-mail body, only to a single substitute address, and may store a pair of the e-mail address of a recipient and a hyperlink address in the address DB 220.

Alternatively, the hyperlink address substitution module 210 of another embodiment may change a plurality of hyperlink addresses, appearing in an e-mail body, to respective different substitute addresses, and associates the e-mail address of a recipient, a hyperlink address, and a substitute address with one another when storing information in the address DB 220, thereby significantly reducing the number of different substitute addresses.

Alternatively, the hyperlink address substitution module 210 of another embodiment may identify a hyperlink address appearing in an e-mail body, and may maintain a corresponding hyperlink address without changing it to a substitute address when it is managed as the hyperlink address of a secure website.

Alternatively, a corresponding hyperlink address may be included in a substitute address itself by constructing the substitute address in the form of “http://TEST.com/hyperlink address/,” and the hyperlink address checking module 310 may identify the corresponding hyperlink address based on the substitute address. In this case, the address DB 220 may pair only the substitute address and recipient information, and may store the paired information.

S20: E-mail Viewing Step

When a recipient accesses and logs in to the e-mail server 100 via the e-mail module 21 which is executes based on the web browser of the receiving terminal 20, the e-mail relay module 110 searches for a received e-mail of the recipient and presents the received e-mail to the e-mail module 21, and the e-mail relay module 110 outputs the presented received e-mail to the receiving terminal 20.

Thereafter, the e-mail module 21 requests an e-mail body, selected by the recipient, from the e-mail relay module 110, and the e-mail relay module 110 searches for the corresponding e-mail body and presents the corresponding e-mail body to the e-mail module 21.

The e-mail module 21 receives and outputs the presented e-mail body.

Through this, the recipient may view the e-mail body on his or her own receiving terminal 20.

Since technology for outputting an e-mail body between the e-mail server 100 and the receiving terminal 20 is well-known technology, a detailed description of a process of viewing an e-mail body is omitted here.

S30: Target Website Identification Step

The recipient selects and clicks on a substitute address in the e-mail body output to the receiving terminal 20, and the web browser of the receiving terminal 20 accesses the checking server 300 corresponding to the substitute address.

The hyperlink address checking module 310 of the checking server 300 identifies the hyperlink address of an original target website which the recipient desires to access by searching the address DB 220 based on one or more selected between the substitute address and the e-mail address of the recipient.

S40: Target Website Access Step

The hyperlink address checking module 310 accesses the original website based on the hyperlink address retrieved from the address DB 220.

S50: Hyperlink Address Maliciousness Checking Step

The checking server 300 of the present embodiment is a type of remote access agent server. The hyperlink address checking module 310 accesses the corresponding hyperlink address by executing its own web browser.

The web browser of the hyperlink address checking module 310 identifies the webpage of the corresponding hyperlink address, and the checking information notification module 320 collects the webpage as a capture image by capturing an image of the webpage, as shown in FIG. 7.

In this case, the hyperlink address checking module 310 generates a virtual area in order to prevent the malware execution of a hyperlink address and the corresponding occurrence of Internet traffic, and access to the hyperlink address is performed within an isolated virtual area. As a result, even when the installation of a malicious program is performed by the execution of malware included in a hyperlink address, the malicious program is installed within the virtual area, and thus the malware does not influence both the hyperlink address checking module 310 and the receiving terminal 20. Since the hyperlink address checking module 310 may delete the virtual area itself or delete external data and additional data stored in the virtual area when the virtual area is contaminated with malware, the checking server 300 may securely communicate with the checking target website 30 without the burden of malware.

Thereafter, the checking information notification module 320 transmits the capture image to the checking information verification module 22 of the receiving terminal 20, and the checking information verification module 22 outputs the capture image to the receiving terminal 20, as shown in FIG. 7. The recipient determines whether or not a website in question is a malicious website by verifying the capture image output to the receiving terminal 20, and determines whether to access the website of the corresponding hyperlink address.

S60: Target Website Connection Step

In the present embodiment, the checking information notification module 320 presents recipient-selectable menu options “YES” and “NO” together with the capture image, and connects the web browser of the receiving terminal 20 to a checking target website corresponding to the hyperlink address when it is determined that a connection will be made to the checking target website corresponding to the hyperlink address.

S70: Checking Information Notification Step

Furthermore, the hyperlink address checking module 310 may determine whether or not the website of the hyperlink address is malicious through self-checking. When it is determined that the website of the hyperlink address is malicious, the checking information notification module 320 generates a report containing the corresponding hyperlink address and the type and name of malware, and transmits the report to the checking information verification module 22 of the receiving terminal 20.

The checking information verification module 22 notifies the recipient of a reason for the restriction on the access by outputting checking information in the form of the report.

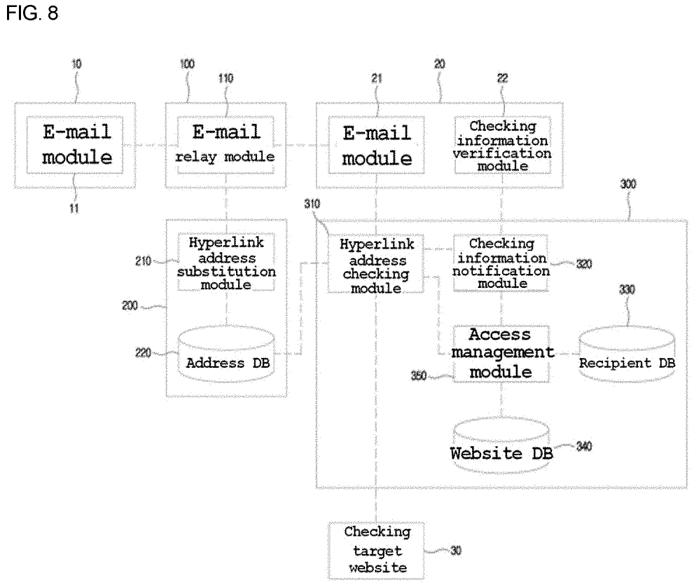

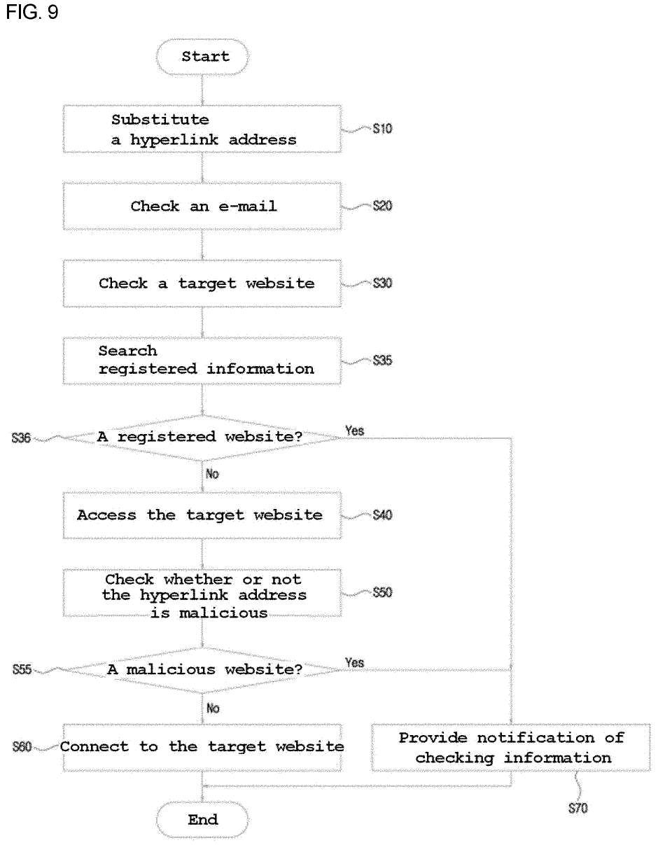

FIG. 8 is a block diagram showing another embodiment of the checking system according to the present invention, and FIG. 9 is a flowchart sequentially showing another embodiment of the checking method according to the present invention.

The checking system of the present embodiment further includes: a website DB 340 which stores one or more selected between secure website address information and malware-contaminated website address information; a recipient DB 330 which stores one or more selected between website address information allowed to be accessed by the recipient and website address information prohibited from being accessed; and an access management module 350 which determines whether to access a hyperlink address based on the website DB 340 and the recipient DB 330.

The website DB 340 may store the website address information of a typical portal website, a corporate website, a public office website, etc. which are accredited websites, and may also store the website address information of websites which are infected with malware.

The recipient DB 330 may store the address information of one or more websites to which access is allowed or prohibited by the recipient.

The access management module 350 first searches the website DB 340 and the recipient DB 330 for the hyperlink address identified by the hyperlink address checking module 310, and determines whether to access before the hyperlink address checking module 310 accesses the corresponding website at steps S35 and S36. When the access management module 350 approves the access, the checking information notification module 320 allows the web browser of the receiving terminal 20 to access the website of the corresponding hyperlink address. In contrast, when the access management module 350 disapproves the access, the checking information notification module 320 generates a report containing the corresponding hyperlink address and the type and name of malware, and transmits the report to the checking information verification module 22 of the receiving terminal 20.

The checking information verification module 22 notifies the recipient of a reason for the restriction to the access by outputting checking information in the form of the report.

For reference, the recipient DB 330 of the present embodiment stores per-recipient identification information, such as the IP address of the receiving terminal 20, the e-mail address of the recipient, or the like, and the access management module 350 may identify access approval or disapproval-related website address information, input for each recipient, based on the identification information.

Although in the present embodiment, the website DB 340 and the recipient DB 330 are described as incorporating their stored data into the checking of the hyperlink address checking module 310, the state of the hyperlink address of a website accredited with security or the hyperlink address of a website approved by the recipient may be maintained without substitution with a substitute address by incorporating the stored data upon substitution with a hyperlink address by the hyperlink address substitution module 210.

Although the description has been given with reference to the preferred embodiments of the present invention in the foregoing detailed description of the present invention, it will be understood by those skilled in the art or those having ordinary skill in the art that various modifications and alterations may be made to the present invention without departing from the spirit and technical scope of the present invention described in the following claims.

1. A system for checking a malicious hyperlink in an e-mail body, the system comprising:
an address DB which stores one or more of a hyperlink address and recipient information, and a substitute address;
a recipient DB which stores identification information of a recipient, and website address information related to whether access has been approved input by the recipient;
a hyperlink address substitution module which extracts a hyperlink address appearing in an e-mail body, substitutes the hyperlink address with a substitute address, and stores one or more of the corresponding hyperlink address and recipient information and the substitute address in the address DB;
a hyperlink address checking module which, when execution of the substitute address by an e-mail module of a receiving terminal having accessed an e-mail server is detected, searches the address DB for the corresponding hyperlink address, accesses a checking target website within an isolated virtual area by means of its own web browser, and checks whether or not the checking target website is malicious;
a checking information notification module which captures a screen of the checking target website accessed by the hyperlink address checking module, transmits a corresponding capture image to the receiving terminal, and transmits a result of the checking of the checking target website from the hyperlink address checking module to the receiving terminal; and
an access management module which searches the recipient DB for the hyperlink address identified by the hyperlink address checking module and determines whether to access the corresponding website based on whether access have been approved for each website address.

2. The system of claim 1, wherein the hyperlink address substitution module receives e-mail data earlier than the e-mail server, substitutes the hyperlink address, and transmits the e-mail data to the e-mail server, or the e-mail server which has received e-mail data transmits a checking target e-mail to the hyperlink address substitution module.

3. The system of claim 1, wherein the hyperlink address substitution module maintains the hyperlink address, excluded from substitution targets, in the e-mail body without substitution.

4. The system of claim 1, further comprising:
a website DB which stores one or more of address information of one or more websites security of which has been confirmed and address information of one or more websites contamination of which with malware has been confirmed;
wherein the access management module searches the website DB for the hyperlink address identified by the hyperlink address checking module, and determines whether to access the corresponding website.

5. A method for checking a malicious hyperlink in an e-mail body, the method comprising:
a hyperlink address substitution step at which a hyperlink address substitution module of a substitution server extracts a hyperlink address appearing in an e-mail body, substitutes the hyperlink address with a substitute address, and stores one or more of the corresponding hyperlink address and recipient information and the substitute address in an address DB;
an e-mail checking step at which an e-mail module of a receiving terminal accesses an e-mail server and checks a received e-mail;
a target website checking step at which a hyperlink address checking module searches the address DB for a hyperlink address for the substitute address and an access management module searches a recipient DB, in which identification information of a recipient and website address information related to whether access has been approved input by the recipient are stored, for the hyperlink address and determines whether to access a website of the hyperlink address;
a hyperlink address checking step at which whether to access the checking target website is determined based on whether to access the hyperlink address determined at the target website checking step, the hyperlink address checking module, when whether to access is not determined at the target website checking step, accesses the checking target website of the hyperlink address retrieved from the address DB and then checks whether the checking target website is malicious within an isolated virtual area, and a checking information notification module captures a screen of the checking target website accessed by the hyperlink address checking module and transmits a corresponding capture image to the receiving terminal;
a step at which the checking information notification module transmits information about a result of the checking of the checking target website and the capture image, received from the hyperlink address checking module, to the receiving terminal; and
a step at which a checking information verification module of the receiving terminal having received the information about the result of the checking and the capture image outputs them.
